(19) United States
(12) Patent Application Publication
(10) Pub. No.: US 2010/0126374 A1
(43) Pub. Date: May 27, 2010

(54) MAGNETOSTATIC LEVITATION AND PROPULSION SYSTEMS FOR MOVING OBJECTS

(76) Inventor: QIGEN JI, Daly City, CA (US)

Correspondence Address: Qigen Ji, 1551 Southgate Ave #232, Dale City, CA, 94015, US

(21) Appl. No.: 12/630,515

(22) Filed: Dec. 3, 2009

Related U.S. Application Data
(63) Continuation-in-part of application No. 12/276,406, filed on Nov. 23, 2008, now abandoned.

(51) Int. Cl. B60L 13/04; H02K 41/02; H02K 7/09; F03D 9/00

(52) U.S. Cl. 104/282; 310/12.09; 310/90.5; 290/55

(57) ABSTRACT

The present invention relates to a novel magnetic suspension and propulsion technologies, which are named as Magnetostatic Suspension (MSS) and Magnetostatic Propulsion (MSP) respectively because of their magnetostatic nature of forces generated. A spring-like magnetic force is produced through interactions between magnets and ferrous materials such as steel. To apply the technologies, four key embodiments of the invention have been invented and described: a MSS and MSP maglev vehicle system in which a vehicle body is lifted up and stabilized by magnetostatic forces above a steel rail both horizontally and vertically; a MSP long-stator linear motor system in which a rotor can be driven up along a magnet-free steel rail or long steel stator; a MSS Permanent Magnet Magnetic Bearing System (PMMB) system in which a steel shaft is levitated standstill by a fully permanent magnets assembly for frictionless rotating; a MSS maglev wind turbine system in which a magnet-free turbine body can hover standstill over a permanent magnet base assembly spinning frictionlessly with low inertia and low cut-in wind speed threshold.

### CROSS-REFERENCE TO RELATED APPLICATIONS

This application is a continuation-in-part of U.S. patent application Ser. No. 12/276,406 filed on Nov. 23, 2008 entitled “MAGNETOSTATIC LEVITATION AND PROPULSION SYSTEMS FOR MOVING OBJECTS”.

### FIELD OF THE INVENTION

The present invention relates to novel magnetostatic suspension and magnetostatic propulsion technologies. A spring-like magnetic force is produced through interactions between magnets and ferrous materials such as steel, which can be used to levitate and/or propel a moving object over a magnet-free steel rail.

### BACKGROUND OF THE INVENTION

The present invention basically relates to a magnetostatic suspension (MSS) and magnetostatic propulsion (MSP) mechanisms between magnets and ferrous or steel rail tracks or shafts, and more specifically, to a magnetostatic suspension and propulsion mechanisms for moving objects, and further more specifically, to a MSS and MSP maglev vehicle technology, in which a vehicle is suspended and propelled by implementing at least three sets of the said MSS and MSP magnet assemblies: one is for levitation, one is for stabilization and guidance and another is for propulsion.

There are currently two primary types of maglev technologies: one called electromagnetic suspension (EMS) uses the attractive magnetic force of a permanent magnet or electromagnet beneath a rail to lift the train up while the other called electrodynamic suspension (EDS) which uses a repulsive force between eddy currents induced in non-ferromagnetic metal conductors and superconducting magnet or permanent magnets to push the train away from the rail. Another experimental technology, which was designed, proven mathematically, peer reviewed, and patented, but is yet to be built, is the magnetodynamic suspension (MDS), which uses the attractive magnetic force of a permanent magnet array near a steel track to lift the train and hold it in place.

In electromagnetic suspension (EMS) systems, the train levitates above a steel rail while electromagnets, attached to the train, are oriented toward the rail from below. The electromagnets use feedback control to maintain a train at a constant distance from the track. The separation between the vehicle and the guideway must be constantly monitored and corrected by computer systems to avoid collision due to the unstable nature of electromagnetic attraction; due to the system's inherent instability and the required constant corrections by outside systems, vibration issues may occur. An EMS system can provide both levitation and propulsion using an onboard linear motor. No wheels or secondary propulsion system needed. Its propulsion system's functions like a rotating electric motor whose stator is cut open and stretched lengthways along the underside of the full guideway and such infrastructure is quite sophisticated and high expenditure.

In electrodynamic suspension (EDS) systems, both the rail and the train exert a magnetic field, and the repulsive force between these magnetic fields levitates the train. The magnetic field in the train is produced by either electromagnets or by an array of permanent magnets. An induced magnetic field in wires or other conducting strips in the track create the repulsive force in the track. At slow speeds, the current induced in these coils and the resultant magnetic flux is not large enough to support the weight of the train. For this reason the train must have wheels or some other form of landing gear to support the train until it reaches a speed that can sustain levitation. EDS systems can only levitate the train using the magnets onboard, not propel it forward. As such, vehicles need some other technology for propulsion. A linear motor (propulsion coils) mounted in the track is one solution. Over long distances where the cost of propulsion coils could be prohibitive, a propeller or jet engine could be used. Propulsion coils on the guideway are used to exert a force on the magnets in the train and make the train move forward. The propulsion coils that exert a force on the train are effectively a linear motor: An alternating current flowing through the coils generates a continuously varying magnetic field that moves forward along the track. The frequency of the alternating current is synchronized to match the speed of the train. The offset between the field exerted by magnets on the train and the applied field create a force moving the train forward. EDS system is unable to levitate vehicles at a standstill, although it can provides levitation down to a much lower speed. Wheels are required for the system.

The current Maglev trains are not compatible with conventional track, and therefore require a new infrastructure for their entire route. This new infrastructure is high expenditure because of the drive or inductive coils must be embedded in the track along its full length. By contrast conventional high speed trains such as the TGV are able to run at reduced speeds on existing rail infrastructure, thus reducing expenditure where new infrastructure would be particularly expensive (such as the final approaches to city terminals), or on extensions where traffic does not justify new infrastructure. The weight of the large electromagnets in EMS and EDS is a major design issue. A very strong magnetic field is required to levitate a massive train. For this reason one research path is using superconductors to improve the efficiency of the electromagnets.

The present invention also relates specifically to a magnetostatic propulsion (MSP) technology for long-stator linear motor (LSLM), in which a magnet assembly as a rotor can be driven along a fully steel shaft or stator assembly without magnets or winding coils attached to. This MSP LSLM technology provides a low budget long distance and no wheel transportation feasible by eliminating permanent magnets from long stator and possibly expensive position sensor and encoder as well. Also this MSP technology gives more compact drive thrust or force and is featured with easy thrust, speed and brake control than its current linear servo motor counterpart.

A conventional linear motor is just an open cut of a conventional rotary motor in which its rotor is made of winding coils and its stator is made of a magnet rail. Its rotor and stator becomes a moving part or forcer and a magnet rail. Linear motor technology is becoming increasingly popular as applications take advantage of its technology. In most linear servo motor technology, the forcer is a set of windings while the stator is a rail of magnets. With all those merits of the linear motors, but the cost of linear motors are expensive. This is because the price of permanent magnets and low volume of production as well. Since most linear motor designs mount rare earth magnets to the length of the rail, and the cost of these magnets is high, especially in cases of long travel linear motors (ex. Maglev rail) the cost of the magnet rail could be prohibitive. Linear feedback unit must also be considered in the cost of using a linear motor. Linear motors typically require a linear encoder for feedback. These devices are many times more expensive than their rotary counterparts. Also, linear motors are not compact force generators compared to a rotary motor with a transmission offering mechanical advantage. A linear motor's no friction can be a problem because without some resistance in the system, it is hard to position quickly and accurately.

The present invention also relates specifically to a magnetostatic permanent magnet bearing technology (MSS PMMB) in which a magnet assembly as a bearing chock passively levitates a steel shift assembly in fully static state and allows the shaft assembly frictionless rotation. No extra electromagnetic balance assisting as in the current AMP technology is required. Apparently a MSS PMMB system includes only permanent magnets and can eliminate all those complexity, high expense and instability inherited in AMB technology. MSS PMMB is a revolutionary technology, which can be used widely in industries for many applications, such as motor and maglev wind turbine. The suspension is passive and energy free or green. In MSS wind turbine application, as another embodiment of this technology under this category, it can output strong suspension per magnet weight used and dramatically reduce weight load to the wind turbine because all magnets are mounted onto a base rather the turbine body. This technology also makes the wind energy conversion more efficient and much low maintenance and extended life cycle to the wind turbine.

A magnetic bearing is a bearing which supports a load using magnetic levitation. Magnetic bearings support moving machinery without physical contact, for example, they can levitate a rotating shaft and permit relative motion without friction or wear. They are in service in such industrial applications as electric power generation, petroleum refining, machine tool operation and natural gas pipelines. They are also used in the Zippe-type centrifuge used for uranium enrichment. Magnetic bearings are used in turbomolecular pumps where oil-lubricated bearings are a source of contamination. Magnetic bearings support the highest speeds of any kind of bearing; they have no known maximum relative speed.

It is difficult to build a magnetic bearing using permanent magnets due to the limitations imposed by Earnshaw's theorem, and techniques using diamagnetic materials are relatively undeveloped. As a result, most magnetic bearings require continuous power input and an active control system to hold the load stable. Because of this complexity, the magnetic bearings also typically require some kind of back-up bearing in case of power or control system failure. Two sorts of instabilities are very typically present with magnetic bearings. Firstly attractive magnets give an unstable static force, decreasing with greater distance, and increasing at close distances. Secondly since magnetism is a conservative force, in and of itself it gives little if any damping, and oscillations may cause loss of successful suspension if any driving forces are present, which they very typically are. An active magnetic bearing (AMB) consists of an electromagnet assembly, a set of power amplifiers which supply current to the electromagnets, a controller, and gap sensors with associated electronics to provide the feedback required to control the position of the rotor within the gap. These elements are added to its complexity and sophastication. The power amplifiers supply equal bias current to two pairs of electromagnets on opposite sides of a rotor. This constant tug-of-war is mediated by the controller which offsets the bias current by equal but opposite perturbations of current as the rotor deviates by a small amount from its center position. The gap sensors are usually inductive in nature and sense in a differential mode.

Magnetic bearing advantages include very low and predictable friction, ability to run without lubrication and in a vacuum. Magnetic bearings are increasingly used in industrial machines such as compressors, turbines, pumps, motors and generators. Magnetic bearings are commonly used in watt-hour meters by electric utilities to measure home power consumption. Magnetic bearings are also used in high-precision instruments and to support equipment in a vacuum, for example in flywheel energy storage systems. A flywheel in a vacuum has very low windage losses, but conventional bearings usually fail quickly in a vacuum due to poor lubrication. A new application of magnetic bearings is their use in artificial hearts. AMB bearing system's disadvantages include high cost, and relatively large size and complicated control circuit system.

### SUMMARY OF THE INVENTION

It is an object of this invention to provide magnetostatic suspension (MSS) and magnetostatic propulsion (MSP) technologies that provide spring-like suspension and propulsion forces between magnets and steel rails or steel shafts.

It is another object to provide a novel MSS and MSP maglev vehicle system as an embodiment of the present invention. In this system, MSS and MSP technologies are used in its levitation, stabilization, guidance and propulsion assemblies to produce lifting and driving forces between permanent magnets or electromagnets and ferrous or steel rail track. This system is more stable, wheel-less, standstill levitated, compatible with conventional rail track, unsophisticated, low cost and safe with no derailing.

It is a further object to provide novel magnetostatic propulsion (MSP) or long stator linear motor (MSP LSLM) technology for applications such as the said maglev vehicle system as another embodiment of the present invention. The propulsion happens between a rotor magnet assembly and a magnet-free long stator steel rail.

It is also a further object of this invention to provide a novel magnetostatic permanent magnet bearing (MSS PMMB) technology for industrial machines such as compressors, turbines, pumps, motors and generators. A MSS PMMB maglev wind turbine is also a key embodiment under this category. This novel magnetic bearing technology is fully permanent magnet made and features with high levitating force output per magnet weight used, and elimination of complexity in the current active magnetic bearing (AMP). This technology makes a light weighted and efficient wind turbine possible with less rotational inertia and low cut-in wind speed. Besides, it is also a more stable suspension technology due to its spring-like force nature between magnet and steel.

Additional advantages, objects and novel features of the present invention will become apparent to those skilled in the art upon examination of the following and by practice of the invention, and spirit of the present invention can be further employed in numerous other embodiments.

### BRIEF DESCRIPTION OF THE DRAWINGS

FIG. 1-1 shows schematically three typical configurations of the said magnetostatic suspension (MSS) and magnetostatic propulsion (MSP) of the present invention.

FIG. 1-2 shows schematically three typical enhanced configurations of the said magnetostatic suspension (MSS) and magnetostatic propulsion (MSP) of the present invention.

FIG. 2-1 shows schematically a typical MSS and MSP maglev vehicle system as one embodiment of the present invention.

FIG. 2-2 shows schematically typical MSS suspension and MSP propulsion assemblies and a derivative MSS suspension configuration in the maglev vehicle system.

FIG. 3 shows schematically a typical MSP long stator linear motor system (LSLM) as another of the embodiments of the present invention.

FIG. 4 shows schematically a MSS permanent magnet magnetic bearing (PMMB) system as another embodiment of the present invention.

FIG. 5 shows schematically a typical MSS maglev wind turbine system as one embodiment of the present invention.

### DETAILED DESCRIPTION OF THE INVENTION

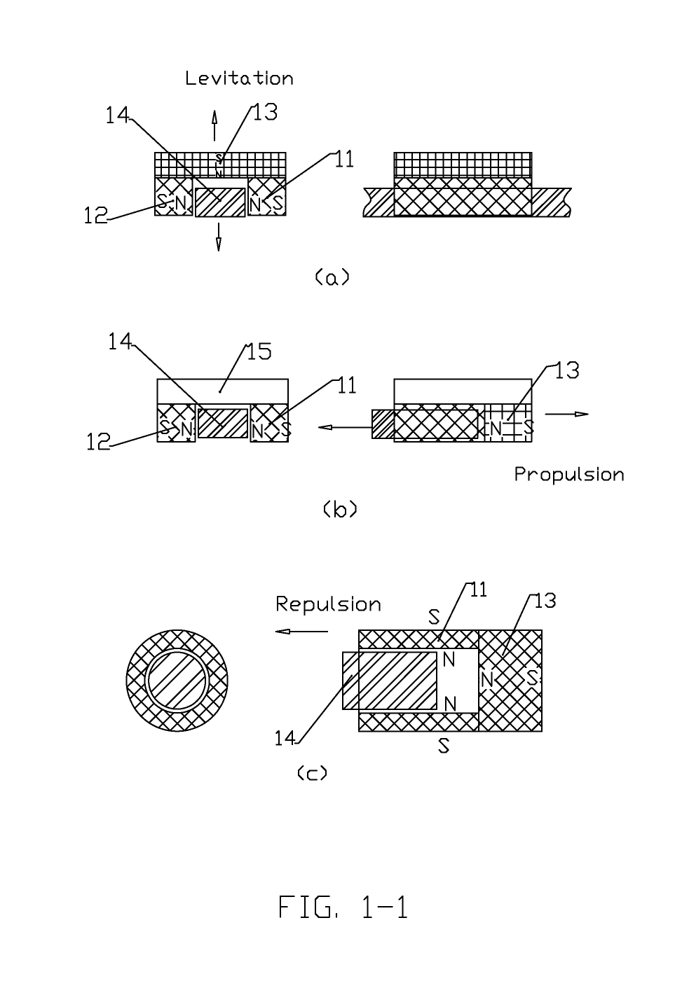

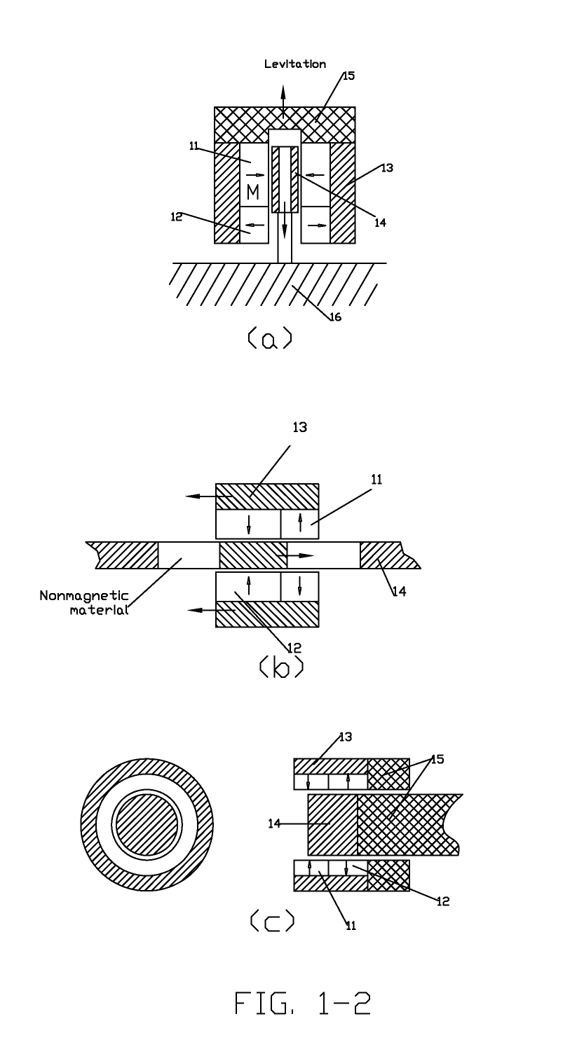

FIG. 1-1 shows three typical basic MSS and MSP configurations (a), (b) and (c). Magnets 11, 12 and 13 in (a), (b) and magnets 11,13 in (c) are arrayed in a way as illustrated in the figure that the magnets 11 and 12 have their same magnetization poles facing each other to create a strong gradient magnetic field in a space between them and that field magnetizes the ferrous material or steel rail 14 into a permanent-like magnet, resulting a repulsive force between the steel rail 14 and the magnet 13 as arrowed in the figure. The configuration (a) is one of magnetostatic suspension (MSS) that provides levitation to a magnet assembly consisting of the magnets 11, 12 and 13 above from the ferrous rail track 14. The configuration (b) is one of magnetostatic propulsion (MSP) that provides propulsion on a magnet assembly consisting of the magnets 11, 12 and 13 away from the steel block 14. The magnets are supported through a nonmagnetic frame 15. The configuration (c) is another magnetostatic suspension (MSS) that provides a steel shaft 14 with shock absorption or force cushioning or pressure on a steel shaft 14 from an assembly consists of the magnets 11, 13 here the magnet 11 is a radially magnetized ring magnet. In the MSS configuration (a), by angling the magnet 13's magnetization both suspension (vertical) and propulsion (horizontal) forces could be achieved. Both the MSS and MSP forces are magnetostatic when the magnets used are permanent magnets or electromagnets flowed with constant currents. The magnet assembly consisting of the magnets 11, 12 and 13 can be operatively attached to bottom of a moving object, and the ferrous or steel rail 14 can be operatively a rail track. Thus suspension and propulsion are produced between a moving object and its rail track.

The MSS suspension force is inherently stable vertically because it is more like a spring force. In the configuration (a) of FIG. 1-1, when the steel rail 14 is inside cavity of the magnet assembly a repulsive force between the magnet 13 and the steel rail 14 increases as a gap between decreases (accompanying with load increases), and when the steel rail is leaving the magnet assembly an attractive force exists to force the steel rail back inside. To stand still the suspension an external horizontal offset force would be needed to balance the rail horizontally because there is a unstable leftward or rightward force exists between the steel rail and the magnets 11 and 12 when the steel rail is not in a exact center position in the cavity. The external offset force could be a pair of adjustable electromagnets or one or two such MSS assembly but is laid down. The magnets 11, 12 and 13 in the configurations (a), (b) and the magnets 11 and 13 in the configuration (c) are permanent magnets, electromagnets or superconducting magnets or a mixture of all the aforementioned. Current flowing in an electromagnet can be either constant or alternative depends on a particular function desired in a practice. The rail 14 is generally made of a soft ferromagnetic material, such as ferrous steel, but also a mixture of different substance including at least a soft ferromagnetic material.

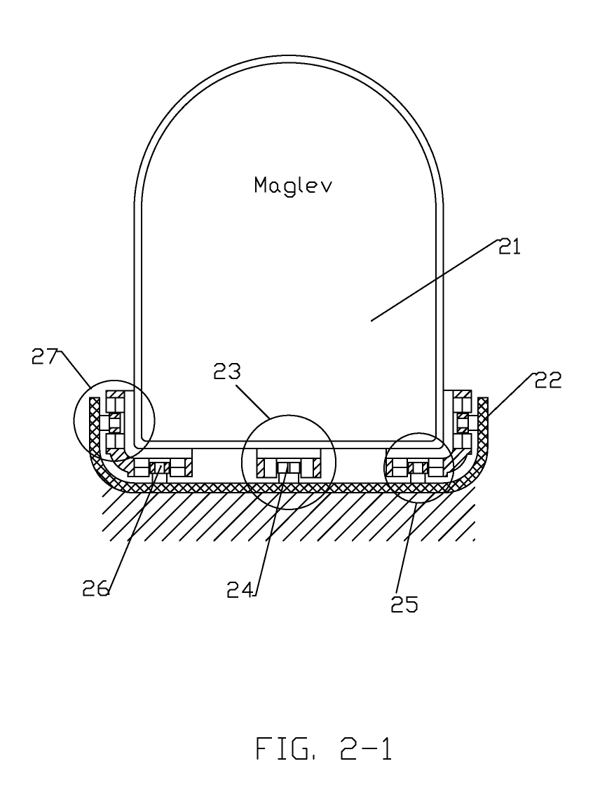

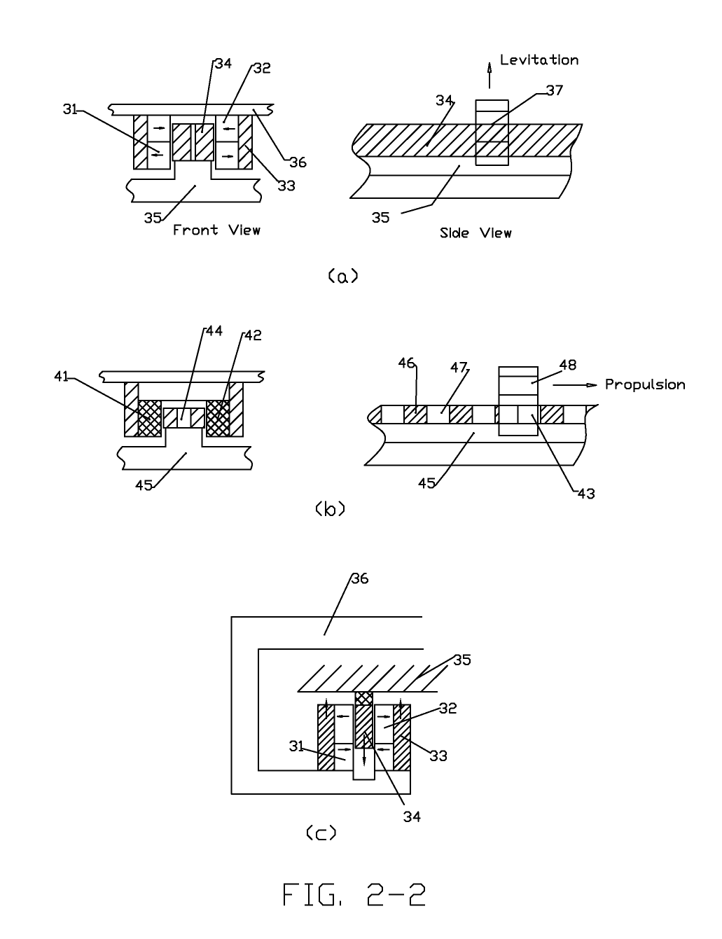

The above descriptions to FIG. 1-1 are just exemplary of the spirit of the present invention and diversity of such as quantity of magnet used; the geometries and alignments of the magnets are not limited or confined by the above description. An embodiment of the present invention could be more complex consisting a number of such basic configurations. FIG. 1-2 shows description of enhanced MSS and MSP configurations corresponding to the configurations (a), (b) and (c) illustrated in FIG. 1-1. Suspension and propulsion are strengthened in the configurations (a), (b) and (c) in FIG. 1-2 by actually combining together two basic configurations in FIG. 1-1. The configuration (a) is one of enhanced MSS type that consists of two pairs of magnets 11 and 12 with their magnetization aligned as indicated in the figure, resulting a strong spring-like resilient force on the steel rail 14 in between. A steel flux return path 13 is added in to increase flux output inside the cavity and shield the magnet field as well. The vertical force as arrowed in the figures is spring-like and always towards an origin position or zero force point and increases as a displacement of the steel rail from the zero force point increases. The force always tends to bring the steel rail back to the origin position. This feature makes derailing a maglev vehicle impossible as the vehicle is always pulled back to the rail. Usually this origin position is a dividing line of the two magnet pairs but a shift is possible that depends on symmetry of the assembly. Again horizontally the steel rail or the magnet assembly of the magnets 11,12 and flux return path 13 are not stable and an external force would be needed to offset horizontally the leftward or rightward force in case the steel rail is not in center position of the cavity. Again the external force could be a pair of adjustable electromagnets or a laid down MSS assembly. A ferrous or steel rail 14 inside the cavity of the magnet assembly is mounted onto a nonmagnetic base or track foundation 16. In order to reduce the unstable leftward or rightward forces the steel rail 14 is made of two smaller steel plate rails separated by a nonmagnetic metal plate rail, as illustrated in the figures. The configuration (b) of FIG. 1-2 is one of enhanced MSP type that consists the same two pairs of magnets 11, 12 and flux return paths 13 with their magnetizations aligned as illustrated in the figure to produce a spring-like horizontal or propulsion force on a steel rail 14. In case of the long steel rail is made of a whole steel, when the magnet assembly moves along the steel rail, the propulsion force is actually zero because the force's spring-like nature. In order to obtain no-zero net propulsion force the rail must be made of alternating magnetic and nonmagnetic block substances at a spacing pattern and the magnetic field of the magnet assembly must be adjustable to match the alternation of the rail. Only then the propulsion along desired direction can be picked while that of the opposite direction is cancelled, resulting a next force. For that reason the magnet pairs 11 and 12 in the MSP configuration must be electromagnets or a mixture of electromagnets and permanent magnets. The configuration (c) of FIG. 1-2 is another enhanced MSS type that consists of the same two pairs of ring magnets 11, 12 and flux return path 13 assembled to produce a pressure on the steel shaft 14.

The general concept involved here in this invention of magnetostatic suspension (MSS) and magnetostatic propulsion (MSP) technologies are that a ferrous metal or a soft ferromagnetic substance can be magnetized into a permanent magnet temporarily to produce a temporary attractive or repulsive force as desired. The concept is essential when applied to a long distance transportation such as maglev vehicle system because basically a long steel rail can be turned into a permanent magnet wherever the vehicle go above without a huge amount of magnets being physically installed along the rail's full length. To achieve this the only thing needs to do is equipping the vehicle with a magnet assembly that is used to magnetize the steel rail underneath. Usually a steel material attracts to a magnet because a single magnet always generates a magnetic field that its field gradient vector aligns oppositely with its magnetic field. In this invention, the unique aligned magnet array generates a high gradient field vector aligns along the field that functionally imposes the ferrous or steel rail a repulsive force as two permanent magnets do when facing their poles each other.

FIG. 2-1 shows schematically a cross-section view of a magnetostatic suspension (MSS) and magnetostatic propulsion (MSP) maglev vehicle system, as a primary embodiment of the present invention. The system consists basically three major assemblies: a MSS levitation assembly 25, a MSP propulsion assembly 23 and a MSS stabilizing and guidance assembly 27. A vehicle body 21 and its vertical undercarriage magnets assembly 23, 25 and 27 are levitated and propelled against ferrous or steel rail tracks 24 and 26, which are mounted onto non-ferromagnetic elevated structures of a track way 22. The vehicle body is levitated at standstill and propelled through the magnetostatic forces produced between the magnets assembly 23, 25 and the ferrous rail tracks 24 and 26. A group of said MSS and MSP assemblies might be used in a maglev system in order to obtain enough weight suspension and propulsion power. In this embodiment the ferrous or steel rail tracks 24 and 26 are more like the ones in a conventional rail track, no coils or other sophistication or a skyway required. Appropriate geometries of the steel rail are indeed required to meet desired lifting and propelling forces. It is a low budget system to build and operate than the current maglev systems. The assembly 27 is for transversal balance and guidance by offsetting the rightward or leftward forces incurred by the levitation assembly 25. It usually is made of electromagnets because its force produced is required to be adjustable and a mixture of permanent magnets and electromagnets is a good consideration when a light weighted vehicle and powerful force output desired. The spring-like force featured in this invention makes the levitation and propulsion very stable, easy control and holds the vehicle body tightly to the rail that totally eliminates the possibility of derailment that is possible in current EMS and EDS systems.

FIG. 2-2 shows the typical assemblies of 24, 25 and 27 of the maglev vehicle system in FIG. 2-1. FIG. 2-2(a) is a schematic description of the MSS assemblies 25 and 27 in FIG. 2-1. A ferrous or steel rail 34 fits inside cavity of a magnet assembly 37 consisting of magnet pairs 31 and 32 that are attached to bottom of a vehicle body 36. The magnet pairs 31, 32 and flux return paths 33 are assembled in a way that generates a spring-like force on the steel rail 34 that is mounted on a non-magnetic elevated structure 35 of a railway foundation. The magnets used in this assembly are permanent magnets such as Neodymium Iron Boron, but possibly electromagnets or superconducting magnets or a mixture of any two or three of the aforementioned. FIG. 2-2(b) shows a schematic description of the MSP assembly 24 in FIG. 2-1. A magnet assembly 48 is attached operatively to the vehicle body. It can be a pair of electromagnets but a mixture of permanent magnets and electromagnets is sometime preferable in cases of both controllability and weight reduction required. A rail 44 is made of alternating magnetic and nonmagnetic material block for the reasons as discussed in above sections. FIG. 2-2(c) shows a derivate MSS suspension structure similar to the one used in current EMS maglev vehicle system. The levitation magnet assembly 25 is positioned beneath the rail track 35, but with distinct differences. The MSS magnet assembly in FIG. 2-2(c) is fully made of permanent magnets instead of electromagnets, and the MSS suspension is spring-like that results in no derailment and elimination of the constant gap correction between vehicle and rail in the current EMS system.

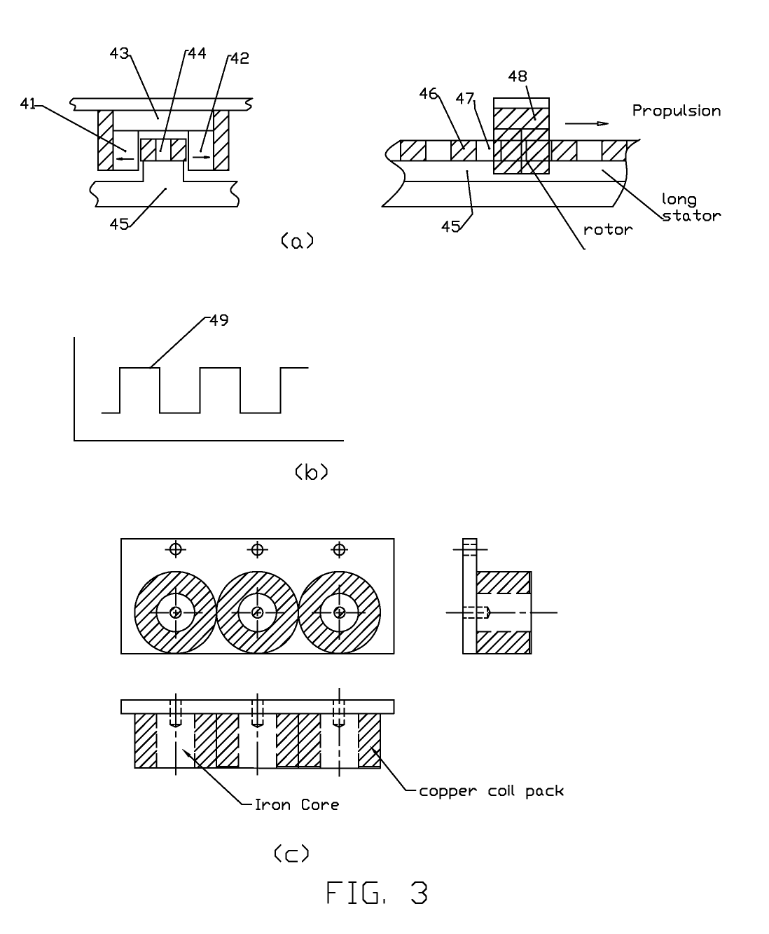

FIG. 3 shows schematic description of a MSP long stator linear motor (LSLM) as a second embodiment of the present invention. Assembly (a) in FIG. 3 is a schematic cross section and side view of the MSP LSLM that consists of a rotor assembly 48 and a long stator or steel rail assembly 44. The rotor assembly 48 is basically the similar one as illustrated in FIG. 1-2(b) and FIG. 2-2(b) that consists of two pairs of magnets 41 and 42. The magnets are electromagnets or a mixture of permanent magnets and electromagnets. The long stator or steel rail is made of alternating magnetic block 46 and nonmagnetic block 47 on a spacing pattern for the reasons above discussed. The electromagnets can be switched on or off by flowing a current with a waveform like 49 in FIG. 3(b) to match alternative positioning of the magnetic block 46 in between to pick up one direction propulsion force desired. By changing this matching the rotor or vehicle's acceleration or deceleration or applying brake can be functioned. The positioning of the magnetic block 46 is feed back through a position sensor to a control circuit to regulate current to the rotor assembly. FIG. 3(c) is schematic description of a typical rotor assembly 48, which consists three pairs of coil packs or electromagnets. Each coil is applied with a separated current flow but the phases of all currents are related and coordinated through a circuit. The assembly can be extended to include as many pairs of the coil pack as desired so that a required propulsion power can be met.

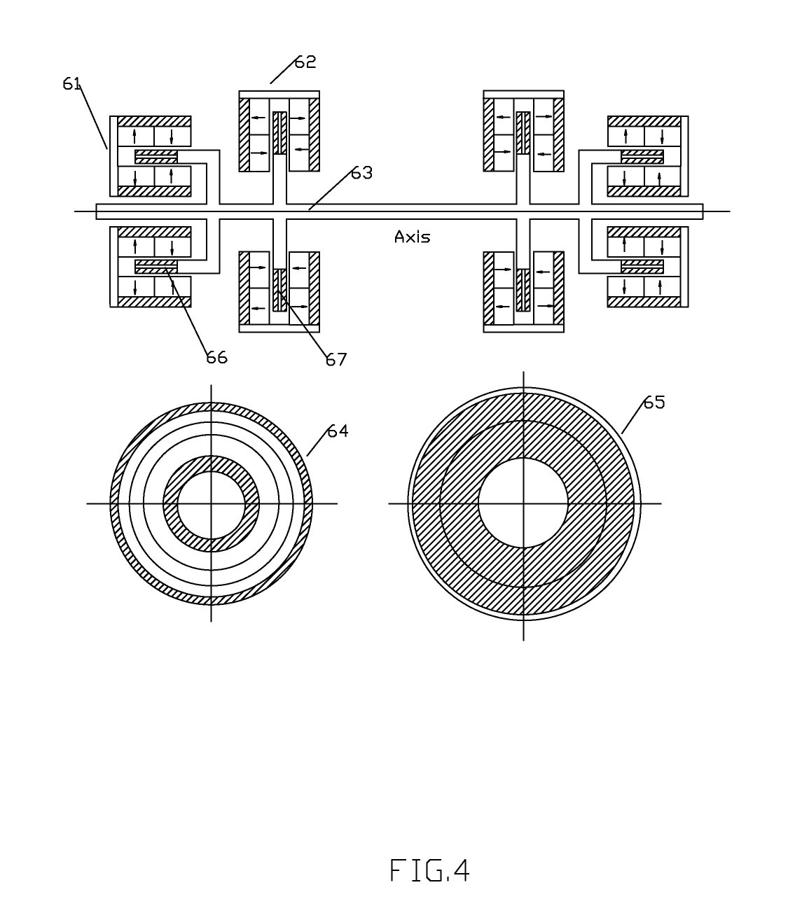

FIG. 4 shows a schematic cross-section and side views of a MSS permanent magnet magnetic bearing (PMMB) system as a third embodiment of the present invention. The whole structure is round along a shaft axis. The system consists of two sets of the MSS assemblies 61 and 62 with each set located at each end of a nonmagnetic shaft axis 63. The assembly 61 is to provide the shaft assembly 63 a horizontal spring-like balance force and the assembly 62 is to provide the shaft assembly 63 a spring-like vertical suspension. The assemblies are made of a bearing chock 64 or 65 and a steel ring assembly 66 or 67. Inside the bearing chocks there are two pairs of magnet rings aligned as illustrated to produce a spring-like force on the steel rings 66 and 67. The existence of the unstable rightward or leftward forces discussed above makes it a challenging in designing a MSS PMMB product, but a carefully design can still lead to a fully standstill suspension of the shaft assembly 63 and makes it spin around its axis frictionlessly. One way to do so is to make the steel ring assembly 67 of two smaller steel rings separated by and mounted on a nonmagnetic frame. This design can dramatically reduce the leftward or rightward forces and make the forces be offset by each other the assemblies 61 and 62.

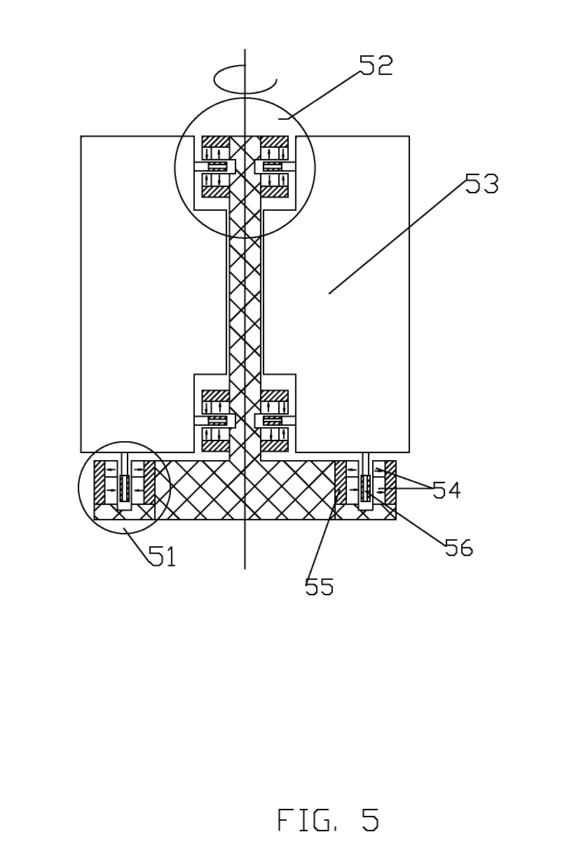

FIG. 5 shows a schematic cross section of a MSS maglev wind turbine as a fourth embodiment of the present invention. The turbine consists of a MSS assembly 51 and two MSS assembly 52. Weight of the turbine 53 is levitated up through the assembly 51 and its rightward or leftward forces are offset through the assembly 52. The assemblies consist of magnets 54, a flux return steel path 55 and steel ring assembly 56. All magnets are operatively attached to a base or foundation of the wind turbine rather than to the turbine body that has great meaning to lightweight the turbine load or inertia. A number of such assemblies might be used to meet a desired weight lifting power. In this design the turbine body can freely move vertically without a gap limitation that makes big sense in allowing a bigger weight variation or moving vibration during operation or loose manufacturing tolerances.

The foregoing descriptions of the invention have been presented for purposes of illustration and description and are not intended to be exhaustive or to limit the invention to the precise form disclosed. Many modifications and variations are possible in light of the above teaching. The embodiments were chosen and described to best explain the principles of the invention and its practical applications to thereby enable others skilled in the art to best use the invention in various embodiments and with various modifications suited to the particular use contemplated. The scope of the invention is to be defined by the following claims.

I claim:

1. A system of magnetostatic suspension (MSS) and/or magnetostatic propulsion (MSP) that provide levitation or propulsion on a moving object comprising at least:
a magnet assembly that is attached to said moving object to generate a gradient magnetic field on a ferrous or steel rail or a steel shaft and produce a spring-like resilient suspension or propulsion to the moving objects;
a ferrous or steel rail or a steel shaft assembly that is positioned in the gradient magnetic field generated by the said magnet assembly to suspend (MSS) or propel (MSP) the moving object above or away from.

2. The magnetostatic suspension (MSS) and/or magnetostatic propulsion (MSP) system of claim 1, wherein the said magnet assembly consists of at least a permanent magnet, or electromagnet, or superconducting magnet or mixture of any two or three of the aforementioned with diversified magnets' alignments, quantities used and geometries as long as functions of producing a spring-like resilient force on a ferrous or steel rail or a steel shaft.

3. The magnetostatic suspension (MSS) and/or magnetostatic propulsion (MSP) system of claim 1, wherein the said ferrous or steel rail or steel shaft assembly consists at least a steel, or another soft ferromagnetic substance or a mixture of magnetic and nonmagnetic materials.

4. The magnetostatic suspension (MSS) and/or magnetostatic propulsion (MSP) system of claim 1, wherein the force generated is generally, but not limited to be, used to provide suspension, propulsion, repulsion, pressure, cushion and shock absorption etc.

5. A long stator linear motor (LSLM) system by employing the MSP technology of claim 1 comprising at least:
a long steel stator assembly; and
a rotor magnet assembly; and
an electric power and speed control circuit for powering, speed regulating and braking.

6. The MSP long stator linear motor system of claim 5, wherein the said long steel stator assembly is a ferrous or steel rail or steel shaft assembly of claim 3 that is specifically made of alternating magnetic blocks and non-ferromagnetic blocks at a spacing pattern along its full length.

7. The MSP long stator linear motor system of claim 5, wherein the said rotor magnet assembly consists at least a magnet assembly of claim 2 that includes at least an electromagnet or superconducting magnet or mixture of electromagnet and permanent magnets to generate a propulsion force on the said long steel stator of claim 6.

8. The MSP long stator linear motor system of claim 5, wherein the said current power and speed control circuit powers the said rotor magnet assembly of claim 7 with an alternative current modulated by a position sensor feedback to implement speed controlling and braking.

9. The MSP long stator linear motor system of claim 5, wherein all magnets' alignments, geometries and quantities used in said rotor magnet assembly of claim 7 are diversified and not confined to any particular description but the function as generating a propulsion force at a desired direction on a ferrous or steel rail or shaft.

10. A maglev vehicle system by employing the MSS and MSP technologies of claim 1 comprising at least:
a vehicle body; and
a MSS assembly for levitation for the said vehicle body; and
a MSS assembly or a pair of electromagnets for horizontal balancing and guidance for the said vehicle body; and
a MSP assembly as a long stator motor for propulsion for the said vehicle body.

11. The MSS and MSP maglev vehicle system of claim 10, wherein the said MSS assembly consist of at least a magnet assembly of claim 2 and a steel rail assembly of claim 3.

12. The MSS and MSP maglev vehicle system of claim 10, wherein the said MSP assembly is a MSP long stator linear motor (LSLM) system of claim 5.

13. The MSS and MSP maglev vehicle system of claim 10, wherein the said vehicle is horizontal balanced and guided through at least a MSS assembly of claim 1 or an electromagnets.

14. The MSS and MSP maglev vehicle system of claim 10, wherein all magnet's alignments, geometries and quantities used in the said MSS or MSP assembly are diversified and not confined to any particular description but the function as generating a spring-like resilient suspension and propulsion for a vehicle body.

15. A permanent magnet magnetic bearing system (PMMB) by employing the MSS technology of claim 1 to provide a standstill suspension for a shaft's frictionless rotation comprising at least:
a set of bearing chock magnet assemblies; and
a bearing shaft assembly.

16. The MSS permanent magnet magnetic bearing system of claim 15, wherein the said bearing chock assembly is made of at least two pairs of permanent magnet rings that assembled in a way to provide spring-like resilient forces on the said bearing shaft assembly both vertically and horizontally and the magnets' alignments and geometries and quantities used are diversified and not confined to any particular description but the function of producing a spring-like resilient force for suspending the shaft assembly frictionless rotating.

17. The MSS permanent magnet magnetic bearing system of claim 15, wherein the said bearing shaft assembly is made of at least a set of steel rings that are separated by and mounted onto a nonmagnetic ring frame and its structure and geometry are diversified and not confined to any particular description but the function of producing a standstill suspension for its frictionless rotating.

18. A maglev wind turbine system by employing the MSS technology of claim 1 to provide weight lifting and frictionless rotating to a wind turbine comprising at least:
a wind turbine body;
a bearing chock magnet assemblies; and
a bearing shaft assembly;

19. The MSS maglev wind turbine system of claim 18, wherein the said bearing chock is the one of claim 16 that is mounted on a base and the magnets' alignments, geometries and quantities used are diversified and not confined to any particular description but the function of producing a spring-like resilient levitation or axis positioning balancing to a wind turbine body for its frictionless rotating.

20. The MSS maglev wind turbine system of claim 18, wherein the said bearing shaft ring assembly is the one of claim 17 consists of at least a set of steel rings that separated by and mounted on a nonmagnetic supporting frame and its alignments, geometries and quantities used are diversified and not confined to any particular description but the function of producing a spring-like resilient levitation and position balancing force to the wind turbine for its frictionless rotating.
